(19) United States
(12) Patent Application Publication
(10) Pub. No.: US 2006/0108347 A1
(43) Pub. Date: May 25, 2006

(54) Firing furnace and method for manufacturing porous ceramic fired object with firing furnace

(75) Inventors: Tatsuya Koyama, Gifu (JP); Koji Higuchi, Gifu (JP)

Correspondence Address: NIXON & VANDERHYE, PC, 901 NORTH GLEBE ROAD, 11TH FLOOR, ARLINGTON, VA, 22203, US

(73) Assignee: IBIDEN CO., LTD., Gifu (JP)

(21) Appl. No.: 11/313,757

(22) Filed: Dec. 22, 2005

Related U.S. Application Data
(63) Continuation of application No. PCT/JP05/14316, filed on Aug. 4, 2005.

(30) Foreign Application Priority Data
Aug. 6, 2004 (JP) 2004-231127

(51) Int. Cl. F27D 11/00

(52) U.S. Cl. 219/388; 264/44

(57) ABSTRACT

A firing furnace for firing a firing subject. The firing furnace includes a housing including a firing chamber and a plurality of heat generation bodies arranged in the housing and generating heat with power supplied from a power supply to heat the firing subject in the firing chamber. At least one of the plurality of heat generation bodies includes a plurality of resistance heater elements connected in parallel to the power supply.

### CROSS-REFERENCE TO RELATED APPLICATIONS

This application is a continuation of, and claims the benefit of priority from International PCT Application PCT/JP2005/014316, filed on Aug. 4, 2005, claiming priority from Japanese Patent Application No. 2004-231127, filed on Aug. 6, 2004, the entire contents of which are incorporated herein by reference.

### BACKGROUND OF THE INVENTION

The present invention relates to a firing furnace, and more particularly, to a resistance-heating firing furnace for firing a molded product of a ceramic material and a method for manufacturing a porous ceramic fired object with the firing furnace.

A molded product of a ceramic material is typically fired in a resistance-heating firing furnace at a relatively high temperature. An example of a resistance-heating firing furnace is disclosed in JP-A 2002-193670. This firing furnace includes a plurality of rod heaters arranged in a firing chamber (muffle) for firing a molded product. A material having superior heat-resistance is used for the resistance-heating firing furnace to enable firing at high temperatures. In the conventional firing furnace, electric current is supplied to the rod heaters to generate heat. The radiation heat from the rod heaters heats and sinters the molded product in the firing chamber to manufacture a ceramic sinter. The contents of JP-A 2002-193670 are incorporated herein by reference in their entirety. As shown in FIG. 5, in the conventional resistance-heating sintering, a plurality of rod heaters 100 are connected in series to a power supply 101. SUMMARY OF THE INVENTION One aspect of the present invention provides a firing furnace for sintering a firing subject, the firing furnace including a housing including a firing chamber, and a plurality of heat generation bodies arranged in the housing for generating heat with power supplied from a power supply to heat the firing subject in the firing chamber, wherein at least one of the plurality of heat generation bodies includes a plurality of resistance heater elements connected in parallel to the power supply.

Another aspect of the present invention is a method for manufacturing a porous ceramic fired object. The method includes the steps of forming a firing subject from a composition containing ceramic powder, and firing the firing subject with a firing furnace including a housing having a firing chamber and a plurality of heat generation bodies arranged in the housing and generating heat when supplied with power from a power supply to heat the firing subject in the firing chamber, wherein at least one of the plurality of heat generation bodies includes a plurality of resistance heater elements connected in parallel to the power supply.

In one embodiment, the plurality of heat generation bodies are connected in series to the power supply. In one embodiment, the plurality of heat generation bodies are arranged adjacent to each other. In one embodiment, the plurality of heat generation bodies are arranged in the housing so as to sandwich the firing subject. It is preferred that the plurality of heat generation bodies are arranged above and below the firing subject. In one embodiment, one of the two heat generation bodies sandwiching the firing subject includes resistance heater elements connected in parallel to the power supply. Preferably, each resistance heater element is made of graphite.

In one embodiment, the firing furnace is a continuous firing furnace for continuously firing a plurality of the firing subjects while conveying the firing subjects. It is preferred that the plurality of heat generation bodies are arranged along the conveying direction of the plurality of firing subjects.

Further aspect of the present invention is a firing furnace for continuously firing ceramic molded products, the firing furnace including a firing chamber, a conveyer for continuously conveying the ceramic molded products to the firing chamber, and a plurality of heater units arranged in the housing and connected in parallel to a power supply. Each heater units include a plurality of resistance heater elements connected in parallel to the power supply for generating heat with power supplied from the power supply to heat the ceramic molded products in the firing chamber.

Other aspects and advantages of the present invention will become apparent from the following description, taken in conjunction with the accompanying drawings, illustrating by way of example the principles of the invention.

### BRIEF DESCRIPTION OF THE DRAWINGS

FIG. 1 is a schematic cross-sectional view of a firing furnace according to preferred embodiment of the present invention;

FIG. 2 is a cross-sectional view of the firing furnace taken along line 2-2 in FIG. 1;

FIG. 3 is a block diagram showing a heat generation circuit of the firing furnace of FIG. 1;

FIG. 4 is a diagram showing a modification of the heat generation circuit of the firing furnace shown in FIG. 1;

FIG. 5 is a block diagram showing a heat generation circuit in a firing furnace of the prior art;

FIG. 6 is a perspective view showing a particulate filter for purifying exhaust gas; and

FIGS. 7A and 7B are respectively a perspective view and a cross-sectional view showing a ceramic member used for manufacturing the particulate filter of FIG. 6.

### DETAILED DESCRIPTION OF THE PREFERRED EMBODIMENTS

A firing furnace according to a preferred embodiment of the present invention will now be described.

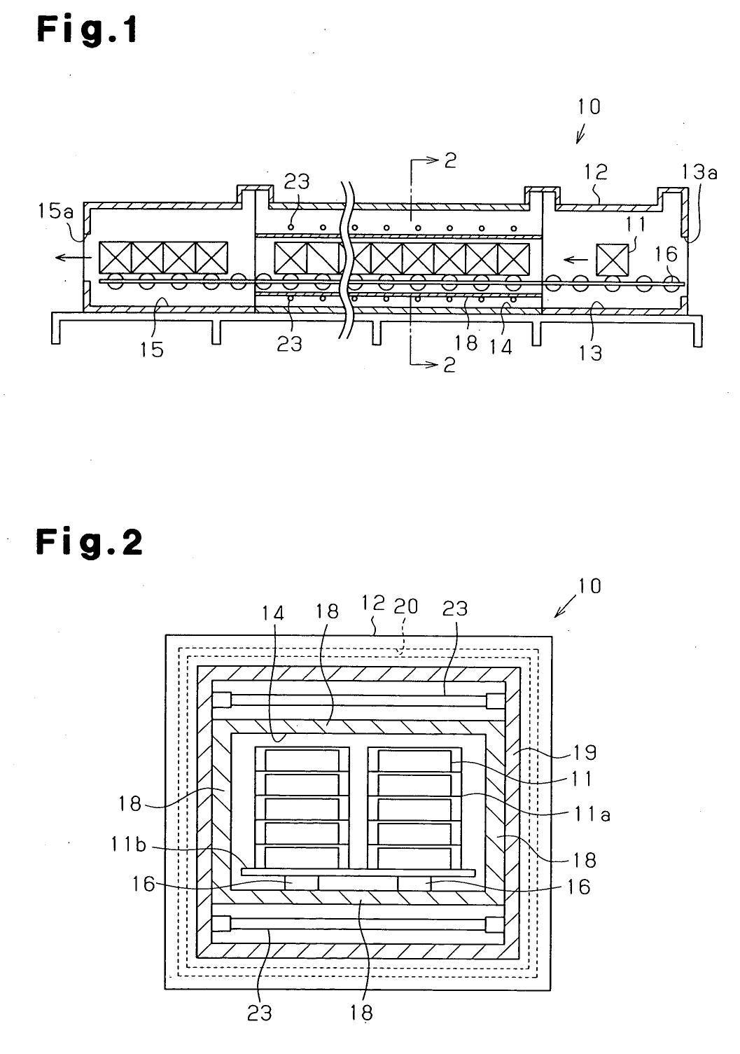

FIG. 1 shows a firing furnace 10 used in a manufacturing process of a ceramic product. The firing furnace 10 includes a housing 12 having a loading port 13a and an unloading port 15a. Firing subjects 11 are loaded into the housing 12 through the loading port 13a, and conveyed from the loading port 13a towards the unloading port 15a. The firing furnace 10 is a continuous firing furnace for continuously firing the firing subjects 11 in the housing 12. An example of a raw material for the firing subjects is ceramics such as porous silicon carbide (SiC), silicon nitride (SiN), sialon, cordierite, carbon, and the like.

A pretreatment chamber 13, a firing chamber 14, and a cooling chamber 15 are defined in the housing 12. A plurality of conveying rollers 16 for conveying the firing subjects 11 are arranged along the bottom surfaces of the chambers 13 to 15. As shown in FIG. 2, a support base 11b is mounted on the conveying rollers 16. The support base 11b supports a plurality of stacked firing jigs 11a. Firing subjects 11 are placed on each of the firing jigs 11a. The support base 11b is pushed from the loading port 13a towards the unloading port 15a. The firing subjects 11, the firing jigs 11a, and the support base 11b are conveyed, by the rolling of the conveying rollers 16, through the pretreatment chamber 13, the firing chamber 14, and the cooling chamber 15 sequentially in this order.

An example of a firing subject 11 is a molded product formed by compression molding a ceramic material. The firing subject 11 is treated in the housing 12 as it moves at a predetermined speed. The firing subject 11 is fired when passing through the firing chamber 14. Ceramic powder, which forms each firing subject 11, is sintered during the conveying process to produce a sinter. The sinter is conveyed into the cooling chamber 15 and cooled down to a predetermined temperature. The cooled sinter is discharged from the unloading port 15a.

The structure of the firing furnace 10 will now be described.

FIG. 2 is a cross-sectional view taken along line 2-2 in FIG. 1. As shown in FIG. 2, furnace walls 18 define an upper surface, a lower surface, and two side surfaces of the firing chamber 14. The furnace walls 18 and the firing jigs 11a are formed of a high heat resistant material such as carbon.

A heat-insulating layer 19 formed of carbon fibers or the like is arranged between the furnace walls 18 and the housing 12. A water-cooling jacket 20 is embedded in the housing 12 for circulating cooling water. The heat-insulating layer 19 and the water-cooling jacket 20 prevent metal components of the housing 12 from being deteriorated or damaged by the heat of the firing chamber 14.

A plurality of rod heaters (resistance heating elements) 23 are arranged on the upper side and lower side of the firing chamber 14, or arranged so as to sandwich the firing subjects 11, in the firing chamber 14. In the embodiment, the rod heaters 23 are each cylindrical and has a longitudinal axis extending in the lateral direction of the housing 12 (in the direction orthogonal to the conveying direction of the firing subjects 11). The rod heaters 23 are held between opposite walls of the housing 12. The rod heaters 23 are arranged parallel to each other in predetermined intervals. The rod heaters 23 are arranged throughout the firing chamber 14 from the entering position to the exiting position of the firing subjects 11.

The rod heaters 23 generate heat when supplied with current and increases the temperature in the firing chamber 14 to a predetermined value. Each rod heater 23 is preferably formed from a heat resistant material such as graphite.

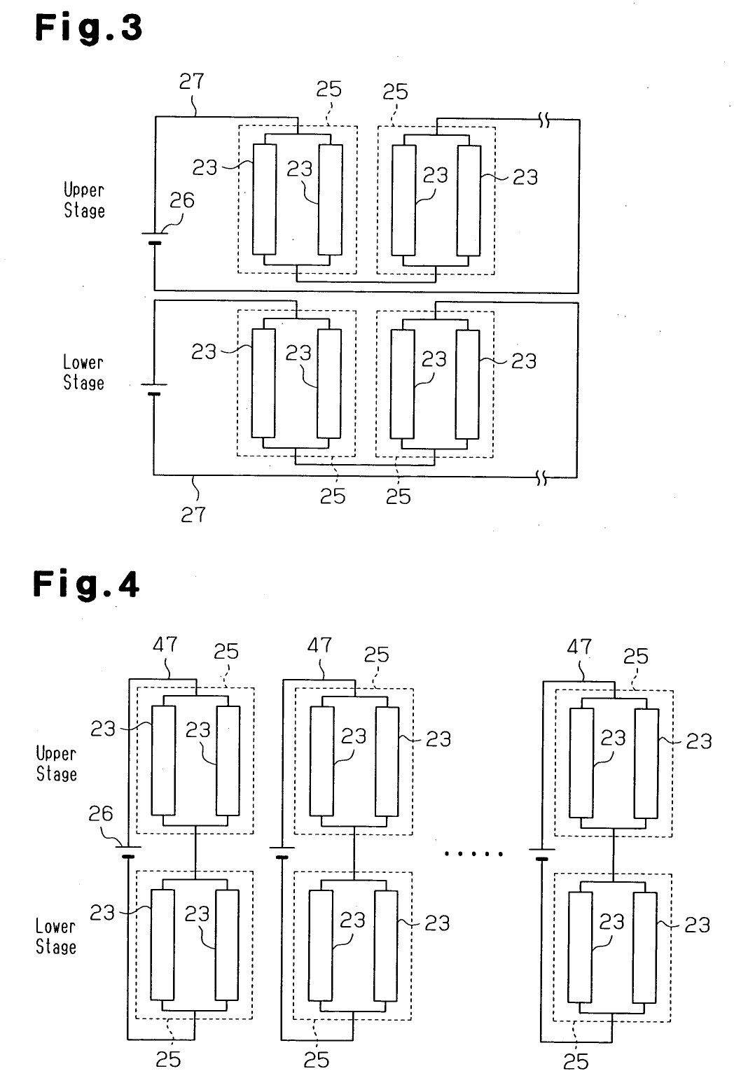

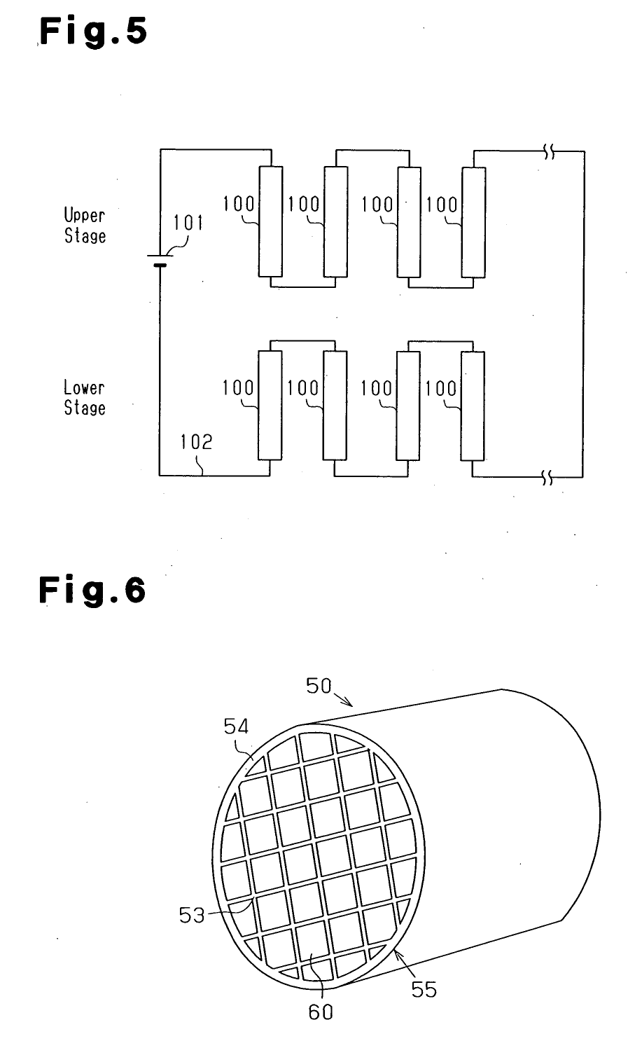

A heat generation circuit of the firing furnace 10 will now be described with reference to FIG. 3. The firing furnace 10 includes at least an upper heat generation circuit and a lower heat generation circuit. Each heat generation circuit includes a power supply 26, a predetermined number of rod heaters 23, and a power supply path 27. The rod heaters 23 shown in the upper stage of FIG. 3 are arranged above the firing chamber 14, and the rod heaters shown in the lower stage of FIG. 3 are arranged below the firing chamber 14.

In the upper stage and the lower stage, the predetermined number of (two in FIG. 3) adjacent rod heaters 23 form one heater unit (heat generation body) 25. The power supply path 27 connects a plurality of heater units 25 and the power supply 26 in series. Further, the power supply path 27 connects the rod heaters 23 in each heater unit 25 to the power supply 26 in parallel.

The plurality of heater units 25 are arranged side by side from the entering position to the exiting position of the firing subjects 11 in the firing chamber 14.

The preferred embodiment has the advantages described below.

(1) Each heater unit 25 has a plurality of rod heaters 23 connected in parallel with the power supply 26. Thus, even if some rod heaters 23 in each heater unit 25 are damaged and become unusable, the remaining rod heaters 23 may generate heat when supplied with current. Since the supply of current to all the heater units 25 is maintained and heat generation of all the heater units 25 continues, the lowering of the temperature in the firing chamber 14 is minimized.

(2) The plurality of heater units 25 are connected in series with respect to the power supply 26, and each heater unit 25 includes a plurality of rod heaters 23 connected in parallel with respect to the power supply 26. With such a connection, even if some rod heaters 23 are damaged and become unusable, the power supply 26 is able to supply current to the remaining heater units 52 through the remaining rod heaters 23 in that heater unit 25. Since the supply of current to all the heater units 25 is maintained and heat generation of all the heater units 25 continues, the lowering of the temperature of the firing chamber 14 is minimized.

(3) The plurality of adjacent heater units 25 are connected in series to the power supply 26. With such a connection, even if some of the rod heaters 23 in one heater unit 25 are damaged and become unusable, the other heater units 25 adjacent to that heater unit 25 continue heat generation. Thus, the temperature of the firing chamber 14 is prevented from being locally lowered in the vicinity of the damaged rod heater 23. The temperature of the firing chamber 14 is uniformly maintained, and the firing subjects 11 are sintered in a preferable manner.

(4) A plurality of heater units 25 each including a plurality of rod heaters 23 are arranged above and below the firing chamber 14. The firing subjects 11 conveyed through the firing chamber 14 are efficiently heated by the radiation heat of the rod heaters 23 from above and below. Even if the firing subjects 11 are stacked in a plurality of stages to increase productivity, the firing subjects 11 are sintered in an optimal manner. Further, even if some rod heaters 23 of some of the heater units 25 are damaged, heating continues, and the firing subjects 11 are sintered in an optimal manner. Thus, the sinters (products) are manufactured with uniform quality such as the inherent resistance value.

(5) The plurality of heater units 25 are arranged throughout the firing chamber. Thus, the temperature of the firing chamber 14 is rapidly increased to a predetermined sintering temperature, and after reaching the sintering temperature, the temperature is maintained so as to continuously heat the firing subjects 11 passing through the firing chamber 14. By controlling electric conduction to each heater unit 25 and adjusting the heating amount of each heater unit 25, an optimal heating profile for continuously sintering a large number of firing subjects 11 is realized.

(6) The firing furnace 10 is a continuous firing furnace in which the firing subjects 11 that enter the housing 12 are continuously sintered in the firing chamber 14. When mass-producing ceramic products, the employment of the continuous firing furnace substantially drastically improves productivity in comparison with a conventional batch firing furnace.

The method for manufacturing a porous ceramic fired object with a firing furnace according to a preferred embodiment of the present invention will now be described.

A porous ceramic fired object is manufactured by molding sintering material to prepare a molded product and sintering the molded product (firing subject). Examples of the sintering material include nitride ceramics, such as aluminum nitride, silicon nitride, boron nitride, and titanium nitride; carbide ceramics, such as silicon carbide, zirconium carbide, titanium carbide, tantalum carbide, and tungsten carbide; oxide ceramics such as alumina, zirconia, cordierite, mullite, and silica; mixtures of several sintering materials such as a composite of silicon and silicon carbide; and oxide and non-oxide ceramics containing plural types of metal elements such as aluminum titanate.

A preferable porous ceramic fired object is a porous non-oxide fired object having high heat resistance, superior mechanical characteristics, and high thermal conductivity. A particularly preferable porous ceramic fired object is a porous silicon carbide fired object. A porous silicon carbide fired object is used as a ceramic member, such as a particulate filter or a catalyst carrier, for purifying (converting) exhaust gas from an internal combustion engine such as a diesel engine.

A particulate filter will now be described.

FIG. 6 shows a particulate filter (honeycomb structure)

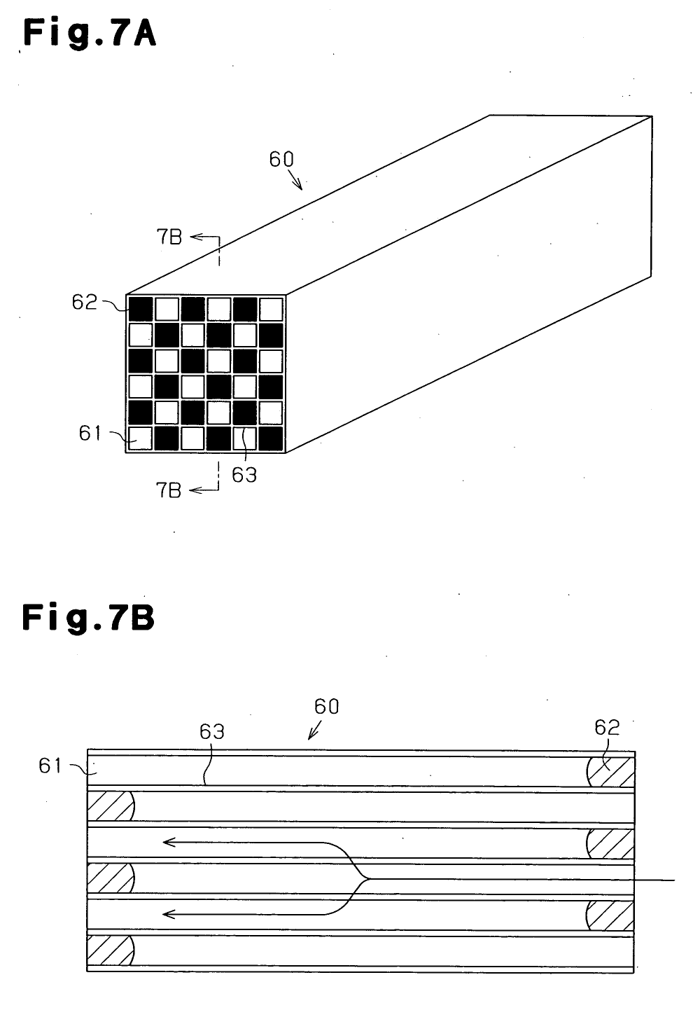

50. The particulate filter 50 is manufactured by binding a plurality of porous silicon carbide fired objects, or ceramic members 60 shown in FIG. 7(A). The ceramic members 60 are bonded to each other by a bonding layer 53 to form a single ceramic block 55. The shape and dimensions of the ceramic block 55 are adjusted in accordance with its application. For example, the ceramic block 55 is cut to a length in accordance with its application and trimmed into a shape (e.g., cylindrical pillar, elliptic pillar, or rectangular pillar) that is in accordance with its application. The side surface of the shaped ceramic block 55 is covered with a coating layer 54.

As shown in FIG. 7(B), each ceramic member 60 includes partition walls 63 defining a plurality of gas passages 61, which extend longitudinally. At each end of the ceramic member 60, the openings of the gas passages 61 are alternately closed by sealing plugs 62. More specifically, each gas passage 61 has one end closed by the sealing plug 62 and another end that is open. Exhaust gas flows into a gas passage 61 from one end of the particulate filter 50, passes through the partition wall 63 into an adjacent gas passage 61, and flows out from the other end of the particulate filter 50. When the exhaust gas passes through the partition wall 63, particulate matter (PM) in the exhaust gas are trapped by the partition wall 63. In this manner, purified exhaust gas flows out of the particulate filter 50.

The particulate filter 50, which is formed of a silicon carbide fired object, has extremely high heat resistance and is easily regenerated. Therefore, the particulate filter 50 is suitable for use in various types of large vehicles and diesel engine vehicles.

The bonding layer 53, for bonding the ceramic members 60, functions as a filter for removing the particulate matter (PM). The material of the bonding layer 53 is not particularly limited but is preferably the same as the material of the ceramic member 60.

The coating layer 54 prevents leakage of exhaust gas from the side surface of the particulate filter 50 when the particulate filter 50 is installed in the exhaust gas passage of an internal combustion engine. The material for the coating layer 54 is not particularly limited but is preferably the same as the material of the ceramic member 60.

Preferably, the main component of each ceramic member 60 is silicon carbide. The main component of the ceramic member 60 may be silicon-containing ceramics obtained by mixing silicon carbide with metal silicon, ceramics obtained by combining silicon carbide with silicon or silicon oxychloride, aluminum titanate, carbide ceramics other than silicon carbide, nitride ceramics, or oxide ceramics.

When about 0 to about 45% by weight of metal silicon with respect to the ceramic member 60 is contained in the firing material, some or all of the ceramic powder is bonded together with the metal silicon. Therefore, the ceramic member 60 has high mechanical strength.

A preferable average pore size for the ceramic member 60 is about 5 to about 100 μm. The ceramic member 60 having an average pore size in a range between about 5 to about 100 μm can not be clogged with exhaust gas and can collect particulate matter in the exhaust gas without allowing the particulate matter passing through the partition walls 63 of the ceramic member 60.

The porosity of the ceramic member 60 is not particularly limited but is preferably about 40 to about 80%. The ceramic member 60 having a porosity in a range between about 40 to about 80% can not be clogged with exhaust gas and the mechanical strength of the ceramic member 60 is improved and thus the ceramic member 60 will not be easily damaged.

A preferable firing material for producing the ceramic member 60 is ceramic particles. It is preferable that the ceramic particles have a low degree of shrinkage during firing. A particularly preferable firing material for producing the particulate filter 50 is a mixture of 100 parts by weight of relatively large ceramic particles having an average particle size of about 0.3 to about 50 μm and about 5 to about 65 parts by weight of relatively small ceramic particles having an average particle size of about 0.1 to about 1.0 μm.

The shape of the particulate filter 50 is not limited to a cylindrical shape and may have an elliptic pillar shape or a rectangular pillar shape.

The method for manufacturing the particulate filter 50 will now be described.

A firing composition (material), which contains silicon carbide powder (ceramic particles), a binder, and a dispersing solvent, is prepared with a wet type mixing mill such as an attritor. The firing composition is sufficiently kneaded with a kneader and molded into a molded product (firing subject 11) having the shape of the ceramic member 60 shown in FIG. 7(A) (hollow square pillar) by performing, for example, extrusion molding.

The type of the binder is not particularly limited but is normally methyl cellulose, carboxymethyl cellulose, hydroxyethyl cellulose, polyethylene glycol, phenolic resin, or epoxy resin. The preferred amount of the binder is about 1 to about 10 parts by weight relative to 100 parts by weight of silicon carbide powder.

The type of the dispersing solvent is not particularly limited but is normally a water-insoluble organic solvent such as benzene, a water-soluble organic solvent such as methanol, or water. The preferred amount of the dispersing solvent is determined such that the viscosity of the firing composition is within a certain range.

The firing subject 11 is dried. One of the openings is sealed in some of the gas passages 61 as required. Then, the firing subject 11 is dried again.

A plurality of the firing subjects 11 is dried and placed in the firing jigs 11a. A plurality of the firing jigs 11a are stacked on the support base 11b. The support base 11b is moved by the conveying rollers 16 and passes through the firing chamber 14. While passing through the firing chamber 14, the firing subjects 11 are fired thereby manufacturing the porous ceramic member 60.

A plurality of the ceramic members 60 are bonded together with the bonding layers 53 to form the ceramic block 55. The dimensions and the shape of the ceramic block 55 are adjusted in accordance with its application. The coating layer 54 is formed on the side surface of the ceramic block 55. This completes the particulate filter 50.

Examples of the preferred embodiment will now be described. It should be understood, however, that the present invention is not limited to these examples.

### EXAMPLES 1 TO 4 AND COMPARATIVE EXAMPLES 1 TO 3

In examples 1 to 4, a heater unit 25 including two or three rod heaters 23 connected in parallel to the power supply 26 was used. A plurality of the heater units 25 were arranged above and below the firing chamber 14 along the conveying direction of the firing subjects 11. Two heater units 25 and the power supply 26 were connected in series to form a heat generation circuit. A test continuous firing furnace 10 including six heat generation circuits was prepared. Connection, position, and diameter of the rod heaters 23 are shown in table 1.

In comparative examples 1 to 3, a heat generation circuit including two rod heaters 23 connected in series with respect to the power supply 26 was used. A plurality of the rod heaters 23 were arranged above and below the firing chamber 14 along the conveying direction of the firing subjects 11. One of the rod heaters 23 arranged above the firing chamber 14 and one of the rod heaters arranged below the firing chamber 14 were connected in series to the power supply 26 to form a heat generation circuit. A test continuous firing furnace including twelve heat generation circuits was prepared.

In examples 1 to 4, even when one of the rod heaters 23 in the heat generation circuit was broken, the temperature of the firing chamber rose to 2200° C. In comparative examples 1 to 3, when one of the rod heaters 23 in the heat generation circuit was broken, the temperature of the firing chamber did not rise to 2200° C.

The rod heaters of examples 1 to 4 and comparative examples 1 to 3 were heat generated over a long period of time to measure the durability of the rod heaters.

Specifically, the time until the rod heater broke due to heat generation was measured. The result is shown in table 1.

When measuring the durability of the rod heater, the firing quality was also measured. Firing was performed over a predetermined time (2000 hours) with the firing subjects 11 stacked in a plurality of rows on the firing jigs 11a. The average pore size of the firing subjects 11 before and after firing was randomly measured. The difference in firing level (firing quality) was evaluated based on the standard deviation of the average pore size. The results are shown in table 1.

TABLE 1

| | | | | | Standard Deviation of Average | |
|---|---|---|---|---|---|---|
| | Rod Heater | Heater | Rod Heater Diameter | | Pore Diameter of Fired Subject | |
| | Connection | Arrangement | (mm) | Durability | Initial | After 2000 hrs. |
| Ex. 1 | two/parallel | upper/lower | 35 (upper)/40 (lower) | 4300 hrs. or longer | 1.11 | 1.58 |
| Ex. 2 | two/parallel | upper/lower | 35 (upper)/40 (lower) | 4300 hrs. or longer | 1.45 | 1.60 |
| Ex. 3 | two/parallel | left/right | 35 (left)/40 (right) | 4300 hrs. or longer | 1.63 | 2.24 |
| Ex. 4 | three/parallel | upper/lower | 30 (upper)/35 (lower) | 3800 hrs. | 1.19 | 1.61 |
| Comp. Ex. 1 | two/serial | upper/lower | 35 (upper)/40 (lower) | 2100 hrs. | 1.26 | 2.43 |
| Comp. Ex. 2 | two/serial | upper/lower | 35 (upper)/35 (lower) | 2100 hrs. | 1.46 | 2.49 |
| Comp. Ex. 3 | two/serial | left/right | 35 (left)/35 (right) | 2100 hrs. | 1.98 | 2.75 |

The durability of the rod heaters of examples 1 to 4 was two times longer than that of the comparative examples 1 to 3.

In the examples 1, 2, and 3, which use the rod heaters that are connected in parallel to the power supply, the difference in the firing degree between the firing subjects 11 is reduced in comparison with the comparative examples 1, 2, and 3, which use the rod heaters that are connected in series to the power supply, when the firing furnace 10 was used over a long period of time (e.g., 2000 hr).

Therefore, the firing furnace of the present invention incorporating the parallel connected rod heaters is capable of mass-producing products of high quality over a long period of time.

### EXAMPLE 5

A method for manufacturing the porous ceramic fired objects with the firing furnaces of examples 1 to 4 will now be described.

A powder of α-type silicon carbide having an average particle size of 10 μm (60% by weight) was wet mixed with a powder of α-type silicon carbide having an average particle size of 0.5 μm (40% by weight). Five parts by weight of methyl cellulose, which functions as an organic binder, and 10 parts by weight of water were added to 100 parts by weight of the mixture and kneaded to prepare a kneaded mixture. A plasticizer and a lubricant were added to the kneaded mixture in small amounts and further kneaded. The kneaded mixture was then extruded to produce a silicon carbide molded product (sintered body).

The molded product was then subjected to primary drying for three minutes at 100° C. with the use of a microwave drier. Subsequently, the molded product was subjected to secondary drying for 20 minutes at 110° C. with the use of a hot blow drier.

The dried molded product was cut to expose the open ends of the gas passages. The openings of some of the gas passages were filled with silicon carbide paste to form sealing plugs 62.

Ten dried molded products (firing subjects) 11 were placed on a carbon platform, which was held on a carbon firing jig 11a. Five firing jigs 11a were stacked on top of one another. The uppermost firing jig 11a was covered with a cover plate. Two of such stacked bodies (stacked firing jigs 11a) were placed on the support base 11b next to each other.

The support base 11b, carrying the molded products 11, was loaded into a continuous degreasing furnace. The molded products 11 were degreased in an atmosphere of air and nitrogen gas mixture having an oxygen concentration adjusted to 8% and heated to 300° C.

After the degreasing, the support base 11b was loaded into the continuous firing furnace 10. They were fired for three hours at 2200° C. in an atmosphere of argon gas under atmospheric pressure to manufacture a porous silicon carbide sinter (ceramic member 60) having the shape of a square pillar.

Adhesive paste was prepared, containing 30% by weight of alumina fibers with a fiber length of 20 μm, 20% by weight of silicon carbide particles having an average particle size of 0.6 μm, 15% by weight of silicasol, 5.6% by weight of carboxymethyl cellulose, and 28.4% by weight of water. The adhesive paste was heat resistive. The adhesive paste was used to bond sixteen ceramic members 60 together in a bundle of four columns and four rows to produce a ceramic block 55. The ceramic block 55 was cut and trimmed with a diamond cutter to adjust the shape of the ceramic block 55. An example of the ceramic block 55 is a cylindrical shape having a diameter of 144 mm and a length of 150 mm.

A coating material paste was prepared by mixing and kneading 23.3% by weight of inorganic fibers (ceramic fibers such as alumina silicate having a fiber length of 5 to 100 μm and a shot content of 3%), 30.2% by weight of inorganic particles (silicon carbide particles having an average particle size of 0.3 μm), 7% by weight of an inorganic binder (containing 30% by weight of SiO₂ in sol), 0.5% by weight of an organic binder (carboxymethyl cellulose), and 39% by weight of water.

The coating material paste was applied to the side surface of the ceramic block 55 to form the coating layer 54 having a thickness of 1.0 mm, and the coating layer 54 was dried at 120° C. This completed the particulate filter 50.

The particulate filter 50 of example 5 satisfies various characteristics required for an exhaust gas purifying filter. Since a plurality of the ceramic members 60 are continuously fired in the firing furnace 10 at a uniform temperature, the difference between the ceramic members 60 in characteristics, such as pore size, porosity, and mechanical strength, is reduced, and thus, the difference between the particulate filters 50 in characteristics is also reduced.

As described above, the firing furnace of the present invention is suitable for manufacturing sintered porous ceramic fired objects.

It should be apparent to those skilled in the art that the present invention may be embodied in many other specific forms without departing from the spirit or scope of the invention. Particularly, it should be understood that the preferred embodiment and examples may be modified and embodied in the following forms.

As shown in FIG. 4, each power supply path 47 may connect the plurality of heater units 25 arranged above and below the firing chamber 14 in series to the power supply 26. In this case, the firing furnace 10 includes at least a heat generation circuit that extends from above to below the firing chamber 14.

Some of the power supply paths 47 may connect the plurality of heater units 25 arranged above the firing chamber 14 in series to the power supply 26, and some of the other power supply paths 47 may connect the plurality of heater units 25 arranged below the firing chamber 14 in series to the power supply 26. Further, some of the other power supply paths 47 may connect the plurality of heater units 25 arranged above and below the firing chamber 14 in series to the power supply 26.

Some heater units 25 may include only the rod heaters 23 connected in series to the power supply 26. For instance, some heater units 25 may be formed from only one rod heater 23.

The heater unit 25 may be formed from three or more rod heaters 23 connected in parallel to the power supply 26. As long as all the parallel connected rod heaters 23 forming one heater unit 25 are not damaged, the supply of current to all the heater units 25 continues. Thus, a larger number of rod heaters 23 are connected in parallel to the power supply 26 in each heater unit 25 reduces the possibility of the firing furnace 10 failing to function and improves reliability. The parallel connected rod heaters 23 therefore function as redundant or margin heater elements in which the heater unit 25 has a tolerance with respect to malfunctioning of the firing furnace 10.

The rod heaters 23 may be modified so that those arranged only above the firing chamber 14 may be connected in parallel with the power supply 26. The number of rod heaters 23 connected in parallel in each heater unit 25 arranged above the firing chamber 14 may be greater than or equal to three, and the number of rod heaters 23 connected in parallel in each heater unit 25 arranged below the firing chamber 14 may be less than three. If each heater unit 25 arranged above the firing chamber 14, at which the temperature is relatively high and thus have a tendency of inflicting damages, has more rod heaters 23 connected in parallel to the power supply, the tolerance with respect to damages of the rod heater 23 becomes high. Thus, the firing furnace 10 is less likely to malfunction and the reliability thereof is enhanced.

The rod heaters 23 may be modified so that those arranged only below the firing chamber 14 may be connected in parallel to the power supply 26. The number of rod heaters 23 connected in parallel to each heater unit 25 arranged below the firing chamber 14 may be greater than or equal to three, and the number of rod heaters 23 connected in parallel in each heater unit 25 arranged above the firing chamber 14 may be less than three. In this case, a temperature increase occurs from a lower portion toward an upper portion of the firing chamber 14. This reduces the difference in temperature in the firing chamber 14.

Each heater unit 25 may be formed by connecting non-adjacent rod heaters 23 in parallel.

The plurality of heater units 25 may be connected in parallel to the power supply 26.

The plurality of heater units 25 may be arranged on the left side and the right side (both side walls of the firing chamber 14) of the firing subjects 11.

The plurality of heater units 25 may be arranged above, below, on the left, and on the right (upper wall, lower wall, both side walls of the firing chamber 14) of the firing subjects 11.

Each heater unit 25 may be formed in any one of the upstream side end, downstream side end, central part, or a range defined by combining any one of these parts in the firing chamber 14.

The rod heater 23 may be formed by materials other than graphite such as a ceramic heating element of silicon carbide or a metal heating element of nichrome wire and the like.

The firing furnace 10 does not have to be a continuous firing furnace and may be, for example, a batch firing furnace.

The firing furnace 10 may be used for purposes other than to manufacture ceramic products. For example, the firing furnace 10 may be used as a heat treatment furnace or reflow furnace used in a manufacturing process for semiconductors or electronic components.

In example 5, the particulate filter 50 includes a plurality of filter elements 60 which are bonded to each other by the bonding layer 53 (adhesive paste). Instead, a single filter element 60 may be used as the particulate filter 50.

The coating layer 54 (coating material paste) may or may not be applied to the side surface of each of the filter elements 60.

In each end of the ceramic member 60, all the gas passages 61 may be left open without being sealed with the sealing plugs 62. Such a ceramic fired object is suitable for use as a catalyst carrier. An example of a catalyst is a noble metal, an alkali metal, an alkali earth metal, an oxide, or a combination of two or more of these components. However, the type of the catalyst is not particularly limited. The noble metal may be platinum, palladium, rhodium, or the like. The alkali metal may be potassium, sodium, or the like. The alkali earth metal may be barium or the like. The oxide may be a Perovskite oxide (e.g., La_{0.75}K_{0.25}MnO₃), CeO₂ or the like. A ceramic fired object carrying such a catalyst may be used, although not particularly limited in any manner, as a so-called three-way catalyst or NOx absorber catalyst for purifying (converting) exhaust gas in automobiles. After the manufacturing a ceramic fired object, the fired object may be carried in a ceramic fired object. Alternatively, the catalyst may be carried in the material (inorganic particles) of the ceramic fired object before the ceramic fired object is manufactured. An example of a catalyst supporting method is impregnation but is not particularly limited in such a manner.

The present examples and embodiments are to be considered as illustrative and not restrictive, and the invention is not to be limited to the details given herein, but may be modified within the scope and equivalence of the appended claims.

What is claimed is:

1. A firing furnace for firing a firing subject, the firing furnace comprising:
a housing including a firing chamber; and
a plurality of heat generation bodies arranged in the housing and generating heat with power supplied from a power supply to heat the firing subject in the firing chamber, at least one of the plurality of heat generation bodies including a plurality of resistance heater elements connected in parallel to the power supply.

2. The firing furnace according to claim 1, wherein the plurality of heat generation bodies are connected in series to the power supply.

3. The firing furnace according to claim 2, wherein the plurality of heat generation bodies are arranged adjacent to each other.

4. The firing furnace according to claim 1, wherein the plurality of heat generation bodies are arranged in the housing so as to sandwich the firing subject.

5. The firing furnace according to claim 4, wherein the plurality of heat generation bodies are arranged above and below the firing subject.

6. The firing furnace according to claim 4, wherein one of the two heat generation bodies sandwiching the firing subject includes resistance heater elements connected in parallel to the power supply.

7. The firing furnace according to claim 1, wherein each resistance heater element is made of graphite.

8. The firing furnace according to claim 1, wherein the furnace is a continuous firing furnace for continuously firing a plurality of the firing subjects while conveying the firing subjects.

9. The firing furnace according to claim 8, wherein the plurality of heat generation bodies are arranged along the conveying direction of the plurality of firing subjects.

10. A method for manufacturing a porous ceramic fired object, the method comprising:
forming a firing subject from a composition containing ceramic powder; and
firing the firing subject with a firing furnace including a housing having a firing chamber and a plurality of heat generation bodies arranged in the housing and generating heat when supplied with power from a power supply to heat the firing subject in the firing chamber, at least one of the plurality of heat generation bodies including a plurality of resistance heater elements connected in parallel to the power supply.

11. The method for manufacturing a porous ceramic fired object according to claim 10, wherein the plurality of heat generation bodies are connected in series to the power supply.

12. The method for manufacturing a porous ceramic fired object according to claim 11, wherein the plurality of heat generation bodies are arranged adjacent to each other.

13. The method for manufacturing the porous ceramic fired object according to claim 10, wherein the plurality of heat generation bodies are arranged in the housing so as to sandwich the firing subject.

14. The method for manufacturing the porous ceramic fired object according to claim 13, wherein the plurality of heat generation bodies are arranged above and below the firing subject.

15. The method for manufacturing the porous ceramic fired object according to claim 13, wherein one of the two heat generation bodies includes resistance heater elements connected in parallel to the power supply.

16. The method for manufacturing the porous ceramic fired object according to claim 10, wherein each resistance heater element is made of graphite.

17. The method for manufacturing the porous ceramic fired object according to claim 10, wherein the furnace is a continuous firing furnace for continuously firing the plurality of the firing subjects while conveying the firing subjects.

18. The method for manufacturing the porous ceramic fired object according to claim 17, wherein the plurality of heat generation bodies are arranged along the conveying direction of the plurality of firing subjects.

19. A firing furnace for continuously firing ceramic molded products, the firing furnace comprising:
a firing chamber;
a conveyer for continuously conveying the ceramic molded products to the firing chamber; and
a plurality of heater units arranged in the housing and connected in parallel to a power supply, each heater units including a plurality of resistance heater elements connected in parallel to the power supply for generating heat with power supplied from the power supply to heat the ceramic molded products in the firing chamber.

20. The firing furnace according to claim 19, wherein each resistance heater element is a graphite rod heater.
